(19) United States
(12) Patent Application Publication
(10) Pub. No.: US 2015/0205044 A1
(43) Pub. Date: Jul. 23, 2015

(54) Modifying the coating on optical fibres

(71) Applicant: Raman Kashyap, Baie d'Urfe (CA)

(72) Inventor: Raman Kashyap, Baie d'Urfe (CA)

(21) Appl. No.: 14/595,772

(22) Filed: Jan. 13, 2015

Related U.S. Application Data
(60) Provisional application No. 61/930,607, filed on Jan. 23, 2014.

(51) Int. Cl. G02B 6/245; G02B 6/36

(52) U.S. Cl. CPC G02B 6/245; G02B 6/3616

(57) ABSTRACT

This invention relates to the modifying or stripping of primary or secondary coatings on optical fibres by the application of heat such that the coating is entirely or partially removed from the surface over a given length of an optical fibre while a tension is applied in the fibre. Also a clamp to hold the optical fibre when tension is applied.

### FIELD OF THE INVENTION

This invention relates to the modifying or stripping of specialist primary or secondary coatings on optical fibres such that the coating is removed from the surface over a region of the optical fibre without substantially affecting the properties of the optical fibre.

### BACKGROUND OF THE INVENTION

Glass based optical fibres are generally coated with a polymer layer to protect the surface of glass, which would otherwise deteriorate over a period of time. This deterioration process is primarily induced by the action of water vapour, chemicals or mechanical damage from contact with other surfaces. Normally for optical communications the protective coating is an acrylate polymer or soft silicone, depending on the type of cable that the fibre is ultimately housed in. For other applications such as fibre pigtails which need to remain flexible, the primary coating is tightly sheathed in a secondary polymer jacket which protects the primary coating from mechanical damage and adds strength to the lead. For optical fibre jumper cables, the secondary coated fibre may be surrounded by Kevlar fibres and cabled in a plastic tube to provide a rugged structure.

Optical fibres can also be coated with a thin, hard, hermetic coating of carbon to allow the fibre to be used in environmentally harsh conditions such as at elevated temperatures and/or in corrosive surroundings. Recently, polyimide has featured as a specialist coating. This material has excellent mechanical and chemical resistance properties, and has been used widely in industry as a masking material or for providing electrical insulation. Coating optical fibres, for example, allows them to be used in sensing applications. These coating may also reduce the diffusion into the glass of gases such as hydrogen that affect performance of the fibre. These speciality coated fibres make a more rugged fibre structure and are therefore attractive for a number of applications in devices that are used in difficult environments.

It is necessary to remove any such coatings prior to splicing two fibres together, as the polymer may contaminate the fibre end and block the coupling of light from one optical fibre to the other. Generally, the coatings are not exactly concentric with respect to the fibre core, and therefore cannot be used for alignment between two fibre ends. Polymer coating on optical fibres can be removed by mechanical stripping with a wire stripper. This process removes the secondary and primary coating together, leaving the glass fibre bare for cleaving and splicing. Cleanliness and mechanical integrity of the optical fibre are of prime importance when preparing them for splicing. Additionally, any serious degradation of the mechanical or optical properties of the optical fibre may compromise performance of the splice over the long term. Mechanical stripping is difficult for stripping the coating of metal, carbon or polyimide from a coated optical fibre.

Another method of stripping-off most coatings the optical fibre is by immersion of the coated fibre into a bath of hot sulphuric acid. This is a very successful technique but is not generally preferred as it poses severe hazard for the operator in the field. A safer method is needed and this is the subject of our current invention.

In addition, it has been found that some method of stripping the coating from optical fibres create fragile fibres.

### SUMMARY OF THE INVENTION

The present invention provides a novel method for the removal of most primary coatings from the surface of an optical fibre. This is accomplished by applying tension to the optical fibre while applying localized heating to the tip of the fibre or any other region. This may be applied, for example, by a series of weak or continuous electrical discharges or, alternatively, by pulses of light from a tightly focussed laser beam. Such modification can be carried out in a controlled manner so as to allow precise removal of just the coating, without substantially affecting the properties of the optical fibre. This method has been demonstrated to not only remove standard polymer based primary coating, but also metal and polyimide coatings.

The object of the invention may be achieved by applying a controlled electrical discharge or laser light to a local region of the fibre while applying the tension to the optical fibre. In a preferred embodiment of the invention, the discharge or laser light treatment is applied digitally, in short pulses or continuously so that the coating bears the brunt of the heating affect, rather than the underlying optical fibre. The heat supplied to the fibre is only sufficient to remove the coating without melting the fibre.

In an alternative embodiment, the quality of the stripping may be monitored on a video camera for precise removal of difficult coatings, providing visual inspection during the removal of the coating as well feedback to the discharge to control the rate of stripping.

### BRIEF DESCRIPTION OF THE DRAWINGS

FIG. 1 is a schematic representation of a cleaved optical fibre with a specialist primary coating such as polyimide.

FIG. 2 is a schematic representation of a typical arrangement used for stripping of coatings on the optical fibre using an electrical discharge by the method of this invention.

FIG. 3 is a schematic representation of a typical arrangement used for removal of coatings on the optical fibre using a focussed laser beam by the method of this invention.

FIG. 4 is a schematic representation of the tip of the optical fibre, indicating for this embodiment, the area in which the coating removal occurs.

FIG. 5 is a photographic representation after the application of 2 discharge pulses by the method of this invention at the end of a fibre.

FIG. 6 is a photographic representation of the region of optical fibre in which the local removal of the coating takes place in the middle of a fibre.

FIG. 7 is a photographic representation of the fibre after an extended region of the coating has been removed.

FIG. 8 is a schematic representation of the device that transports the optical fibre through the region of the heat zone synchronously with the application of the electrical discharge.

FIG. 9, in a flow chart, illustrates a method for stripping of coatings on the optical fibre in accordance with an embodiment of the present invention.

FIG. 10, in a front cross-sectional view, a clamp for holding an optical fibre to apply tension therein while performing the method of FIG. 9.

FIG. 11, in a partial perspective view, illustrates the clamp shown in FIG. 10.

### DETAILED DESCRIPTION

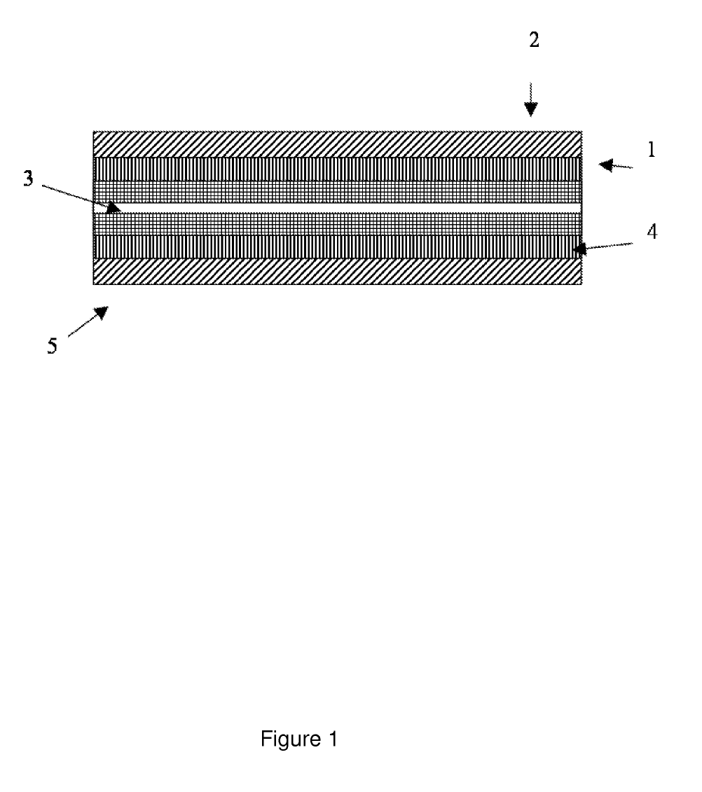

FIGS. 1 shows the cleaved end (1) of an optical fibre (2) with a coating (5).

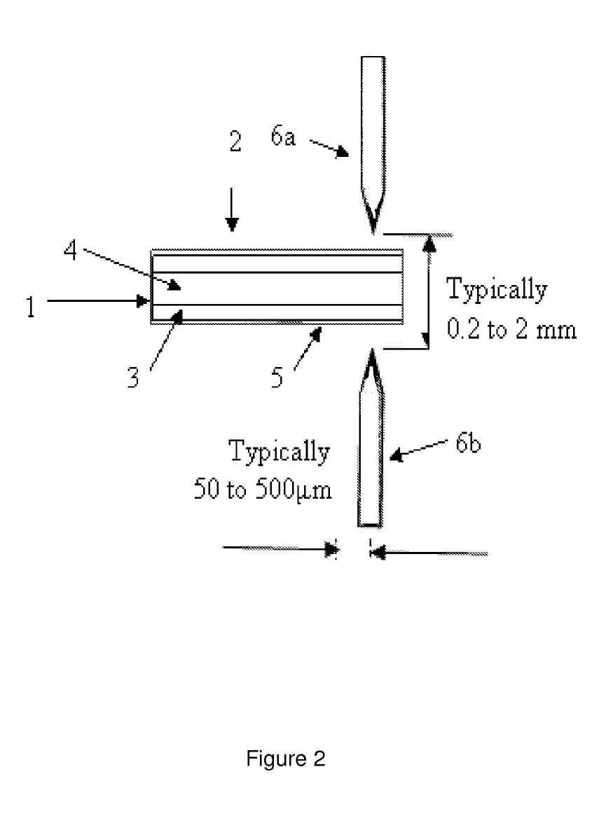

FIG. 2 is a schematic representation of one embodiment of the arrangement used to realize the removal of the coating (5), of this invention. In the prior art, electric-sparks have been used to remove debris loosely deposited on ends of optical fibres prior to fusion splicing of optical fibres by melting the two ends. These sparks are intended only to “kick” off any dirt the end. An optical fibre (2) may have a core (4) and may have a cleaved end (1). The core (4) could for example have a diameter of 1 to 100 microns or greater, while the uncoated fibre could have an overall diameter on the order of 125-500 microns. The cladding could be a single layer, or could be fabricated with two or more layers and both the core and the cladding could have refractive indices which are graded in the radial direction. The optical fibre cladding (3) may be encapsulated in a protective glass or polymer or other coating as shown in FIG. 2, and it may be metallized for soldering or other purposes. The fibre end (1) by which the fibre is terminated could be a cleaved end or a fibre lens fabricated by polishing, etching, drawing, or any other known method, and it could be wedge-shaped or of any other shape suited to the application for which it is intended.

In the embodiment of the invention of FIG. 2, an electrical discharge is established between two electrodes positioned near the tip of the fibre (1). The electrodes (6a and 6b) may be of tungsten, graphite or any other suitable material capable of sustaining a repeated electrical discharge. Representative dimensions are shown in FIG. 2, but these could be adjusted by a person skilled in the art, combined with selection of the electrical parameters of the process, as required to provide the required degree of processing. The electrical pulses causing the electrical discharge between the electrodes (6a and 6b) may be of any suitable intensity and duration, with the geometry selected, for giving a stepwise removal of the coating on the fibre and without melting the fibre. For example, pulses could be in the form of a square wave or any other shape having typically amplitude between one and 500 milliamperes and duration on the order of 1 to 100 microseconds or even continuous. Time between pulses is typically on the order of one tenth of a second but may be less or several seconds or longer, and this time may be controlled either automatically or by manually triggering the treatment pulses. Different types of materials used to make the optical fibre may require either shorter or longer duration discharges as well as greater or smaller discharge currents. It will be evident to a person skilled in the art that the precise geometrical and electrical parameters necessary to achieve the desired result will depend on humidity, atmospheric pressure, type of fibre end, fibre size, fibre type, ambient temperature and many other parameters. Any combination of suitable geometric and electrical parameters that achieves the objects of this invention falls within its scope.

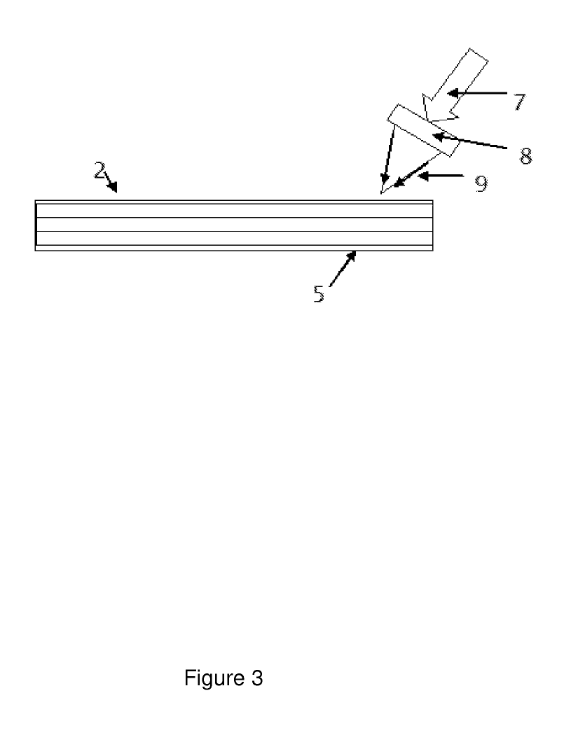

FIG. 3 is a schematic representation of a second embodiment of the arrangement used to realize the coating modification of this invention. A laser beam (7) is focussed by a lens or system of lenses (8) such that the focussed beam (9) is incident on the fibre that is to be stripped. As for the embodiment of FIG. 2, the laser light may be pulsed with pulses of any suitable intensity and suitable duration or continuous, with the geometry selected, for giving a stepwise or continuous removal of the coating on the fibre. Pulses could have duration on the order of 1 to 100 microseconds or more, and time between pulses may be on the order of one tenth of a second or longer and may be controlled either automatically or by manually triggering the treatment pulses. Different types of materials used to make the optical fibre may require either shorter or longer duration pulses as well as greater or smaller intensity of the treatment light. A carbon dioxide laser is well suited to this application. It will be evident to a person skilled in the art that the precise geometrical and laser parameters necessary to achieve the desired result will depend on humidity, atmospheric pressure, type of fibre-end, fibre size, fibre type, ambient temperature and many other parameters. Any combination of suitable geometric and laser parameters that achieves the objects of this invention falls within its scope.

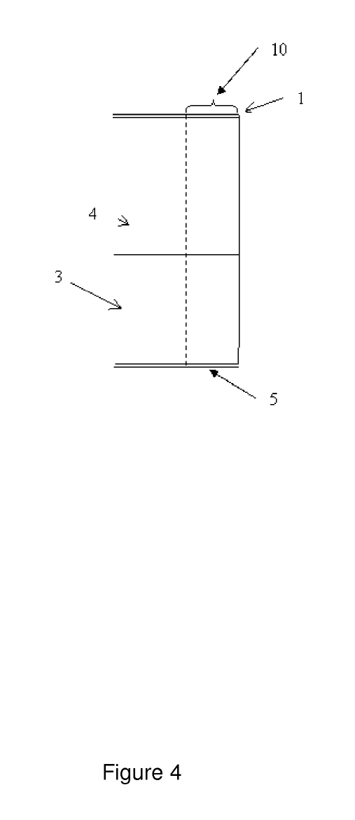

FIG. 4 shows schematically the region (10) of a fibre at which stripping is to be carried out by the method of this invention. The fibre may have a metalization coating or some other coating such as carbon or polyimide coating (5). This metalization may for example be an electrolytically-deposited coating of a few microns of nickel and a thin flash of gold (less than 1 micron). Alternatively, it may be a vacuum deposited coating such as, for example, 50 nm of titanium, 100 nm of platinum and 200 nm of gold. All such metallization coatings can be removed precisely and locally with application of a single or a few electrical discharges or light pulses or by continuous exposure to electrical discharge or laser light, by the method of this invention. The power level is such that a first single, several discharges, light pulses or continuous exposure to electrical discharges or light, do not measurably affect the glass of the fibre, but volatilize the thin metal/polyimide or other coating on the surface of the fibre. Continuing application of discharge or light pulses results in progressive removal of the coating, for example in the region (11).

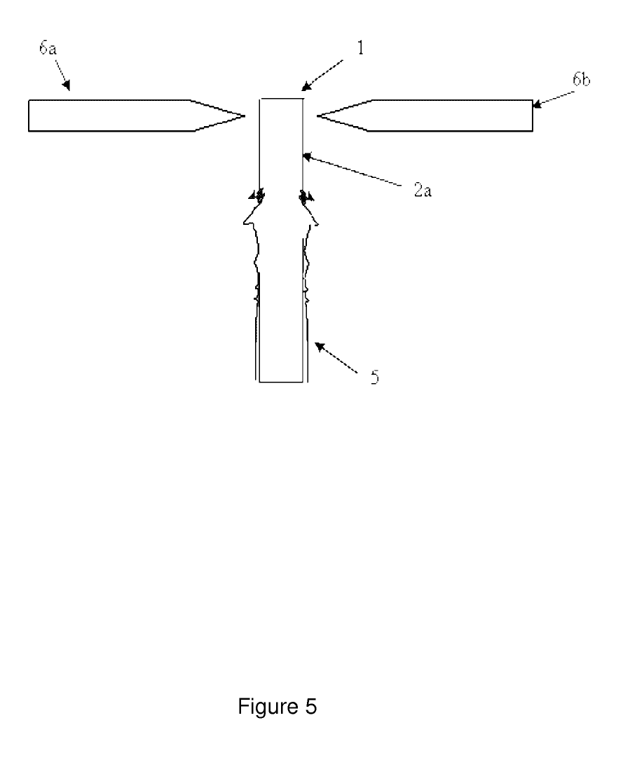

FIG. 5 shows the end of a fibre that has been stripped of its coating. In this case a polyimide coated fibre having a coating of a few microns thick was used. Successive discharges were applied until the best conditions were found to allow the coating to be stripped successfully.

During modification of fibre coating by the method of this invention, it is sometimes useful to monitor the surface visually as shown in FIG. 5, as certain coatings may be difficult to remove and for which a video camera may be used, a technique which also falls within the scope of this invention.

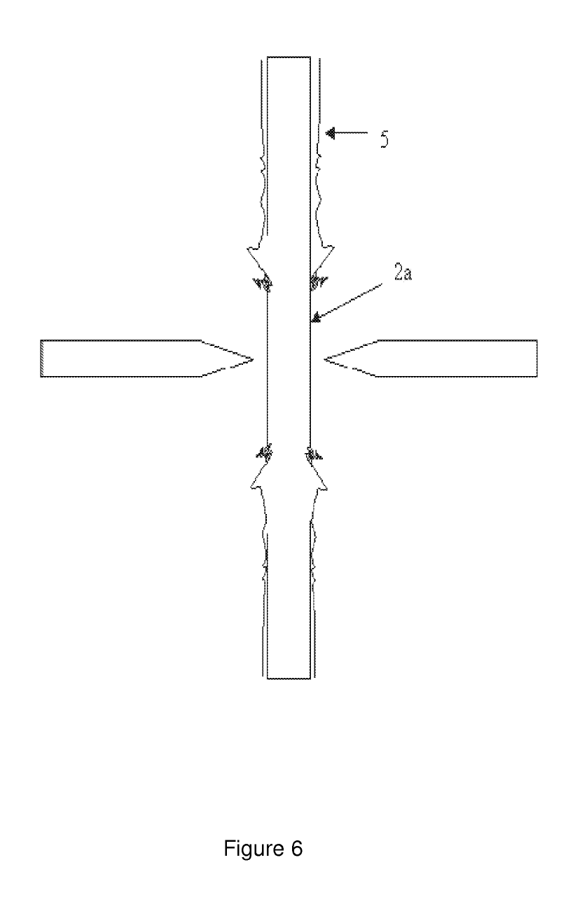

FIG. 6 shows a photograph of a fibre that has been stripped of its polyimide coating in the middle of a coated region using the technique descried in this invention.

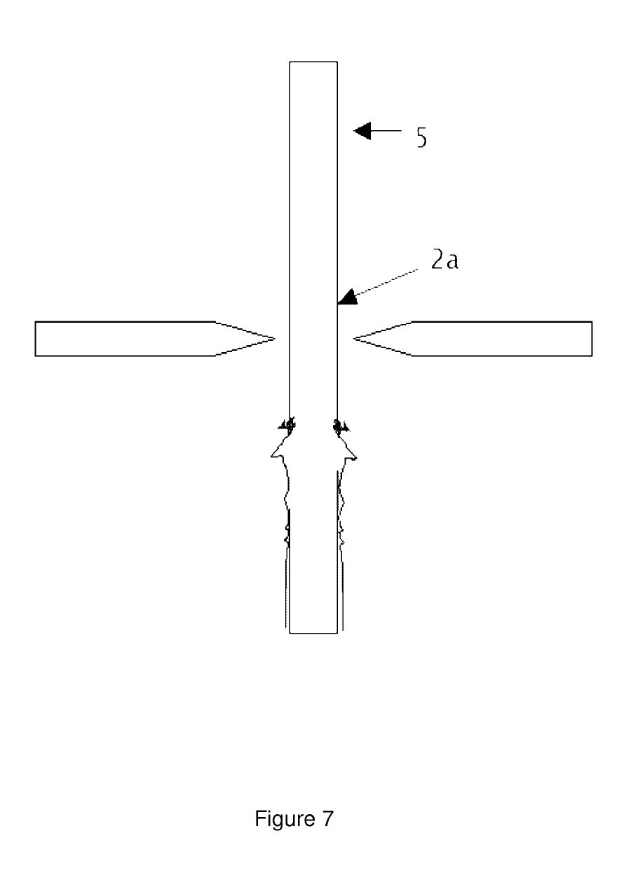

By translating the optical fibre relative to the electrical-discharge at the electrodes (6a, 6b) such that the coated section of the fibre enters or leaves the discharge area, subsequent sections of the optical fibre may be stripped synchronously, thereby extending the region of the stripped fibre to an arbitrary length. FIG. 7 shows an extended stripped region using the technique of translating the fibre. It is clear to a person skilled in the art that the fibre needs to move relative to the discharge or light, so that the fibre could for example be stationary and the electrodes are moved relative to the fibre.

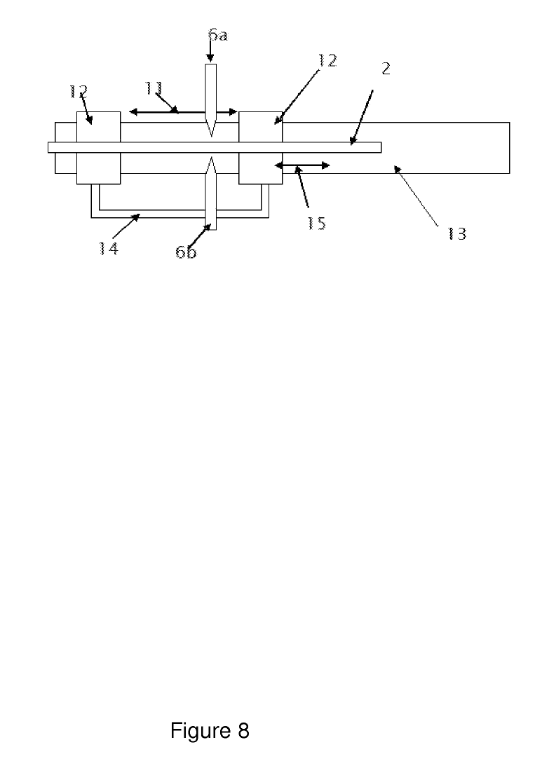

FIG. 8 shows the schematic of the system used to modify extended regions of the coating. The fibre (2) is held in a carriage formed by two optical fibre chucks (12) mounted on translation stages below (12), separated by a distance (11) and linked with a rigid adjustable connector (14). The glide rail (13) allows the stages to move in a given direction perpendicular to the direction of the discharge, so that the fibre remains in the discharge region as shown by the direction arrow (15). It should be understood that this invention is not limited to the specific embodiments described above but that various modifications obvious to those skilled in the art, including the use of the method with optical fibres fabricated from polymer or from different glass compositions, may be made therein without departing from the scope of the following claims.

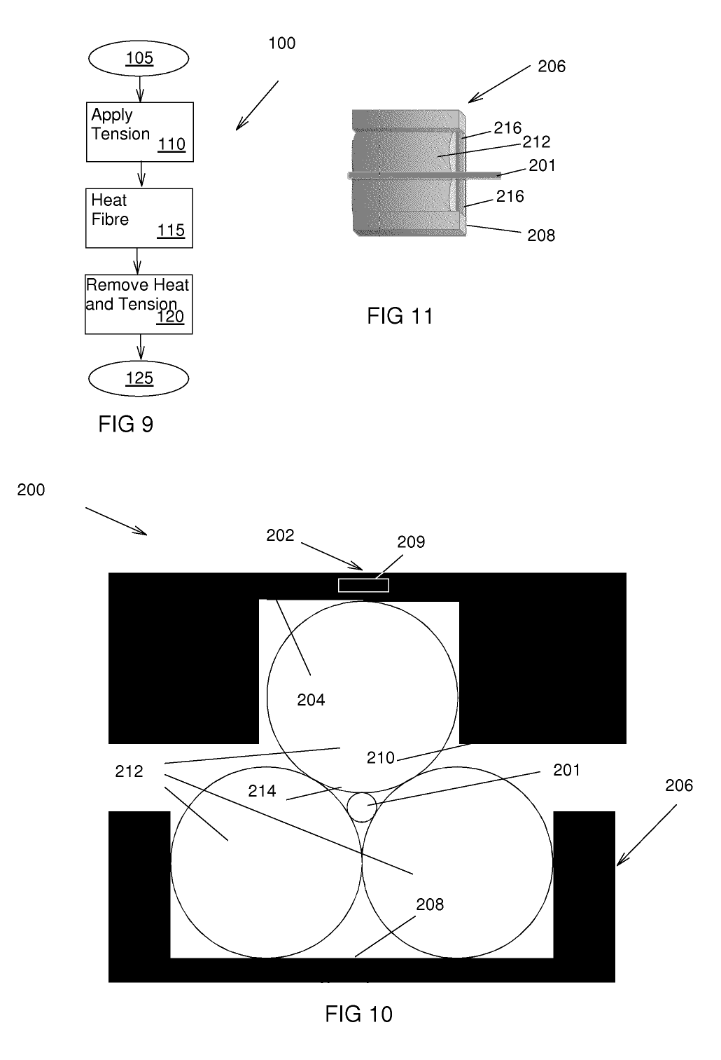

FIG. 9 illustrates in a flowchart a method 100 for for removing at least part of a coating from an optical waveguide, such as an optical fibre. The method 100, a variant of the above describes a method and can use all the variants described hereinabove, but is described herein in relation with the use of an electrical discharge as an example. The method starts at step 105. At step 110, a tension is created in the optical waveguide. Typically, the tension Is larger than or equal to a minimal tensile strength needed when stripping has been achieved. In some embodiments, a tension resulting in a strain of about 1% has been found to be well suitable, but other strain values, for example and non exclusively between 0.5% and 2% are within the scope of the invention. At step 115, the method includes producing an electrical discharge substantially adjacent the coating and heating the coating with the electrical discharge while preserving the tension in the optical waveguide. In alternative embodiments of the invention, any other suitable heating method can be used. At step 120, the electrical discharge is stopped and the tension is released. Finally, the method ends at step 125. Since the coating has been stripped at a given tension and the fiber remains intact, it is apparent that the fiber's breaking strength is greater than the tension applied during srripping, or at least equal to it.

In an example, a specific application required a minimal tensile strength of 100 kpsi. For the tests, a 125 micron diameter fiber coated with 40 microns layer of polyimide was used. A typical length of 150 mm was held with the two clamps described hereinbelow, separated by 100 mm. A micrometer fitted to one clamp is used to apply tension to the fiber. Typically just over 1% strain is applied which is equivalent to ˜100 kpsi. Subsequently, the stripping process is begun, and with the arc parameters used for arc, a 15 mm long length is repeatedly heated with the arc for 9 passages at a speed of between 1 mm-mm per second. Other variants of the settings may also be used and the heat dose can be adjusted by trading off arc energy with speed of fiber movement relative to the arc. The speed also depends on the diameter of the fiber as well as the coating thickness. A person skilled in the art can quickly arrive at a set of values for speed of stripping vs arc strength, for any diameter of fiber and coating. The unstripped fiber was also tested for breaking strength using the setup of these clamps in-situ. For the fiber used, the breaking strength before stripping was measured to be correspond approximately to between 4 and 5% strain. Fibres stripped without applying tension all had a tensile strength of less than 100 kpsi. When a 119 kpsi tension was applied while stripping, all fibres had a tensile strength of more than 100 kpsi, typically 140 kpsi and in some cases up to 180 kpsi.

In some embodiments of the invention, a clamp 200, seen in FIG. 10, is used for holding a section of an optical fibre 201 at each end of the optical fibre 201 to apply the tension. The clamp 200 includes a shell first section 202 defining a first section groove 204 and a shell second section 206 defining a second section groove 208. The shell first and second sections 202 and 206 are reversibly attachable to each other, for example using screws or any other suitable fastener (not shown in the drawings), with the first and section grooves 204 and 208 facing each other substantially in register with each other to create a clamp passageway 210.

Three clamping elements 212 are positionable in the clamp passageway 210 in a triangular configuration abutting each other to create a fibre receiving passageway 214 therebetween, the fibre receiving passageway 214 being contained in the clamp passageway 210. The clamp passageway 210 is configured and sized to receive the clamping elements 212 such that when the shell first and second sections 202 and 206 are attached to each other in an operative configuration, the clamping elements 212 are pressed towards each other. Positioning the section of the optical fibre 201 in the fibre receiving passageway 212 and attaching the shell first and second sections 202 and 206 to each other in the operative configuration clamps the section of the optical fibre 201. In a specific embodiment of the invention, one of the clamping elements 212 is received in the first section groove 204 and two of the clamping elements 212 are received in a side-by-side relationship relative to each other in the second section groove 208. The clamping element 212 received in the first section groove 204 is held nominally in position by a magnet 209 coupled to the shell first section 202 as the first section groove 204 is typically slightly wider than the portion of the clamping element 212 received therein to allow lateral movements thereof to center this clamping element 212 relative to the other clamping elements 112. However, tight fitting of the clamping element 212 in the first section groove 204 is also within the scope of the invention. The clamping elements 212 received in the second section groove 208 are typically tightly fitted therein. In some embodiments, one or both of the first and section grooves 202 and 206 is adjustable in width to accommodate various dimensions of clamping elements 212.

In some embodiments of the invention, the clamping elements 212 are substantially cylindrical. In other embodiments, the clamping elements 212 are of any other suitable shape, such as spherical. In some embodiments of the invention, the clamping elements 212 are all cylindrical with identical radii R. If r is the radius of the optical fibre 201, the following relationship holds when the clamping elements abut against each other and each abut against the optical fibre 201, with the configuration shown in FIG. 10: Cos 30°=R/(R+r). In yet other embodiments, the clamping elements 212 are cylindrical and have different radii. For example, the clamping element 212 received in the first section groove 204 has a radius R1 that differs from a radius R2 of a pair of clamping elements 212 received in a side-by-side relationship relative to each other in the second section groove 208. In that case, the following relationships hold: Cos(theta)=R2/(R2+r); h=R Tan(theta) and R1=(h+r)̂2/2(R−h−r)). In these examples, all three clamping elements 212 abut against the optical fibre 201, but also abut against each other so that the optical fibre 201 is not crushed when the clamping elements 212 are pressed towards each other.

In some embodiments of the invention, the shell first and second sections 202 and 206 are of constant cross-sectional configuration longitudinally therealong. In other embodiments, as seen in FIG. 11 for the second section shell 206, the first and second section grooves 204 and 208 are terminated at both ends thereof by walls 216 to better contain the clamping elements 212. The walls 216 are configured and sized to capture the clamping elements 212 when tension is applied to the fibre 201 while allowing the fibre 201 to exit the clamp 200.

The reader skilled in the art will appreciate that the clamp 200 may also be usable in any other application in which it is desired to firmly hold an optical fibre 201. Also, the method 100 may be performed by holding the optical fibre in any other suitable manner.

1. A method for removing at least part of a coating from an optical waveguide, said coating covering at least in part said optical waveguide, said method comprising:
creating a tension in said optical waveguide;
producing an electrical discharge substantially adjacent said coating; and
heating said coating with said electrical discharge while preserving said tension in said optical waveguide.

2. A clamp for holding a section of an optical fibre, said clamp comprising:
a shell first section defining a first section groove and a shell second section defining a second section groove, said shell first and second sections being reversibly attachable to each other with said first and section grooves facing each other substantially in register with each other to create a clamp passageway;
three clamping elements, said three clamping elements being positionable in said clamp passageway in a triangular configuration abutting each other to create a fibre receiving passageway therebetween, said fibre receiving passageway being contained in said clamp passageway, said clamp passageway being configured and sized to tightly receive said clamping elements such that when said shell first and second sections are attached to each other in an operative configuration, said clamping elements are pressed towards each other;
whereby positioning said section of said optical fibre in said fibre receiving passageway and attaching said shell first and second sections to each other in said operative configuration clamps said section of said optical fibre.
